(19) United States
(12) Patent Application Publication
(10) Pub. No.: US 2003/0088568 A1
(43) Pub. Date: May 8, 2003

(54) Electronic bulletin board system

(76) Inventors: Toshihiko Matsunaga, Osaka (JP); Tatsuya Sukehiro, Osaka (JP); Shin Torigoe, Osaka (JP); Satoshi Nakagawa, Hyogo (JP); Yasuhiro Kawakita, Osaka (JP)

Correspondence Address: Rabin & Berdo, P. C., 1101 14th Street, N. W., Suite 500, Washington, DC, 20005, US

(21) Appl. No.: 09/968,526

(22) Filed: Oct. 2, 2001

(30) Foreign Application Priority Data
Oct. 16, 2000 (JP) 314877/2000

(51) Int. Cl. G06F 17/30

(52) U.S. Cl. 707/10

(57) ABSTRACT

An electronic bulletin board system (BBS) having a translation function is provided.

The BBS is operated to feed at least one of an original message posted through a network from a terminal device connected to a communication network and its translated message to a plurality of terminal devices including the above terminal device. The BBS is provided with a translation section used to produce translated messages corresponding to original messages using a translation machine prior to transmittance of messages to each of the terminal devices and with an information processing section used to hold the original message and translated message and to feed message information including at least one of the original message and translated message, in response to a request from each of the terminal devices, to each of corresponding terminal device.

### BACKGROUND OF THE INVENTION

1. Field of the Invention

The present invention relates to an electronic bulletin board system (hereinafter referred to as a “BBS”) to be operated on a communication network such as the WWW (World Wide Web) through which information is exchanged in a hypertext form and on a conventional personal computer network and more particularly to the BBS being suitably used for the communication network system in which a plurality of different languages is used.

2. Description of the Related Art

Recently, on the Internet are operated a lot of the BBSs in which predetermined topics can be debated on.

Before the emergence of such the BBS using the WWW, a conventional BBS using the personal computer network had existed and have been widely used.

An advantage common to the BBS using the WWW and the conventional BBS using the personal computer network is that they can exchange information (or messages) between one user and many users and among many users.

However, in the conventional BBS described above, generally, a single language is used for the exchange of messages. The language used is one which the user operating the BBS is accustomed to the use of.

For example, in the BBS used by a user whose native language is Japanese and who likes to use Japanese, a message written on the BBS is Japanese and a message read on the BBS and displayed on the screen of the user's terminal device is also Japanese.

Similarly, in the BBS used by a user whose native language is English and who likes to use English, a message written on the BBS is English and a message read on the BBS and displayed on the screen of the user's terminal device is also English.

Such the BBS in which a language being different from one which the user likes to use is employed, in some cases, causes inconvenience.

For example, when the BBS handling a message described in a foreign language is used, the user who wishes to read the message or wishes to post a message on the BBS has to read the message written in such the foreign language being not accustomed to the user and has to write the message in such the foreign language being not accustomed to the user. This work requires skills for using the foreign language and thus presents a difficulty in using the BBS.

Moreover, in the communication network system such as the WWW or personal computer communication system, actually, since English is used as a worldly common language, if a user is an expert in English, the user is able to easily post or to read messages on the BBS in the world. However, all the users are not always skillful in using English, thus producing such difficulties associated with the language as described above.

To solve this inconvenience, a method is proposed in which software adapted to translate messages is installed in advance on the terminal device and, through this translation software, messages are written (or posted) or read on the BBS. However, generally, special terminology is not included in a system dictionary provided by such the translation software and translated words for headwords used to retrieve the terminology are not adequate in some cases. Therefore, the user has to do complicated works including the additional registration of such the terminology on the above dictionary or the installation of new translation software on the user's terminal device.

### SUMMARY OF THE INVENTION

In view of the above, it is an object of the present invention to provide a BBS which enables a user to post or read messages on the BBS in a language being accustomed to the user without the need for the user's individual management of translation software.

According to a first aspect of the present invention, there is provided a BBS connected to a communication network for feeding at least one of an original message posted through the network from a terminal device connected to the network and its translated message to a plurality of terminal devices including the terminal device including:

a translation section to produce the translated message corresponding to the original message posted through the network by translating the original message using a translation machine, prior to feeding of the message, to each of the terminal devices; and

an information processing section to hold the original message and the translated message and to feed message information containing at least one of the both messages in response to a request from each of the terminal devices, to each of the terminal devices.

In the foregoing, a preferable mode is one wherein the information processing section is provided with a storing section to store the original message and the translated message, a message processing section to judge, based on the request from each of the terminal devices, whether the original message is translated using the translation machine or not and to feed the original message to the storing section and with a message feeding section to produce the message information using the message from the storing section and to feed the message information through the network to each of the terminal devices.

Also, a preferable mode is one wherein the message processing section feeds the translated message to the storing section.

Also, a preferable mode is one wherein the translation section is provided with a dictionary section storing translation dictionary data used to perform the translation by the translation machine and with a translation processing section to perform the translation by the translation machine using the dictionary data stored in the dictionary section.

Also, a preferable mode is one wherein the original message and the translated message stored in the storing section are classified by category and wherein the storing section is provided with a managing information section having information about the category.

Also, a preferable mode is one wherein the dictionary section has a plurality of specialized dictionaries classified by the category and common dictionaries other than the specialized dictionaries.

Also, a preferable mode is one wherein the category is so systematized as to have hierarchical structures.

Also, a preferable mode is one wherein the translation processing section is provided with a specialized dictionary selecting section to select the specialized dictionary that corresponds to a category of the original message to be translated and the specialized dictionary that corresponds to a category showing a higher order concept of the category from the specialized dictionaries and with a translation performing section to perform the translation by the translation machine using one or a plurality of the specialized dictionaries selected by the specialized dictionary selecting section.

Also, a preferable mode is one wherein the dictionary section has one or a plurality of user dictionaries that responds to at least one of the terminal devices.

Also, a preferable mode is one wherein each of the user dictionaries is classified by category corresponding to each of the specialized dictionaries.

Furthermore, a preferable mode is one wherein the translation processing section is provided with a user dictionary information section having information about a relation between each of the terminal devices and each of the user dictionaries and with a user dictionary selecting section to select the user dictionaries that meet an instruction, fed from each of the terminal devices, contained in the relation information stored in the user dictionary information section.

According to a second aspect of the present invention, there is provided a BBS connected to a communication network for feeding at least one of an original message posted through the network from each of a plurality of terminal devices connected to the network and its translated message to a plurality of terminal devices including the terminal device including:

a translation section to produce the translated message corresponding to the original message posted through the network by translating the original message using a translation machine prior to feeding of the message, to each of the terminal devices; and

an information processing section to hold the original message and the translated message and to feed message information containing at least one of both the messages in response to a request from each of the terminal devices, to each of the terminal devices.

With the above configurations, the BBS is provided with the translation function and, therefore, a plurality of users using a plurality of languages being different from each other can easily post messages and read messages in accustomed languages.

With another configuration, each of the users having no common language among them can establish a single user community on the same BBS and therefore values in exchange of messages on the BBS is increased.

### BRIEF DESCRIPTION OF THE DRAWINGS

The above and other objects, advantages and features of the present invention will be more apparent from the following description taken in conjunction with the accompanying drawings in which:

FIG. 1 is a schematic block diagram showing configurations of a hypertext system using a BBS according to a first embodiment of the present invention;

FIG. 2 shows an operational sequence in a hypertext system according to the first embodiment of the present invention;

FIG. 3A shows an example of configurations of a posting form (in Japanese) employed in the first embodiment of the present invention;

FIG. 3B shows an example of configurations of a posting form (in English) employed in the first embodiment of the present invention;

FIG. 4 shows an example of a message browsing screen employed in the first embodiment of the present invention;

FIG. 5 is a schematic block diagram showing configurations of a BBS according to a second embodiment of the present invention;

FIG. 6A is a schematic diagram showing an example of a top page displayed on a screen according to the second embodiment of the present invention;

FIG. 6B is a schematic diagram showing an example of a posting form displayed on the screen according to the second embodiment of the present invention;

FIG. 7 shows an operational sequence of the BBS according to the second embodiment of the present invention;

FIG. 8 shows an example of field managing information according to the second embodiment of the present invention;

FIG. 9 is a schematic block diagram showing configurations of the BBS according to a third embodiment of the present invention;

FIG. 10 shows an example of personal information employed in the BBS according to the third embodiment of the present invention;

FIG. 11 shows an operational sequence of the BBS according to the third embodiment of the present invention;

FIG. 12 shows an example of configurations of word registering screen employed in the BBS according to the third embodiment of the present invention;

FIG. 13 is a schematic block diagram showing configurations of a terminal device according to the first embodiment of the present invention; and

FIG. 14 is a schematic block diagram explaining internal configurations of a message registering section according to the first embodiment of the present invention;

### DESCRIPTION OF THE PREFERRED EMBODIMENTS

Best modes of carrying out the present invention will be described in further detail using various embodiments with reference to the accompanying drawings.

In the embodiments described below, a case will be described as an example in which the BBS of the present invention is operated through the WWW adapted to exchange information in a hypertext form such as a well-known HTML (HyperText Markup Language).

### First Embodiment

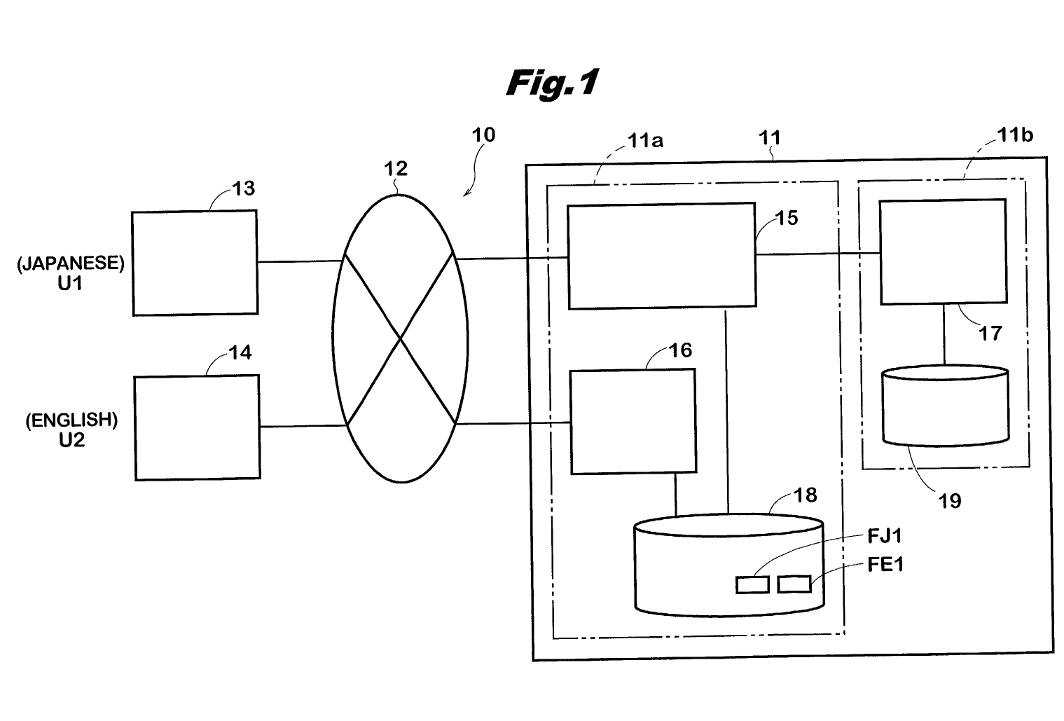

FIG. 1 is a schematic block diagram showing configurations of a hypertext system 10 using the BBS 11 according to a first embodiment of the present invention.

As shown in FIG. 1, the hypertext system 10 includes the BBS 11, a network 12 and terminal devices 13 and 14.

The BBS 11 is the electronic bulletin board system being operated through the WWW.

The network 12 used is the network system in which information in a hypertext form is exchanged and in the example shown in FIG. 1 is the Internet (WWW system).

The terminal devices 13 and 14 are terminal devices that can access the BBS through the network 12, which are provided with hardware such as a bitmap display device (not shown) and with software such as a Web browser. Each of the terminal devices 13 and 14 employs a well-known GUI (Graphical User Interface) that enables a WIMP (Window, Microcomputer, Menu and Pointing device) to be displayed on the display device.

Personal computers, for example, can be used as such terminal devices 13 and 14.

The user can browse HTML documents (hypertext) described in HTML by using functions of the Web browser incorporated in the terminal device 13 (14).

The HTML documents are documents in which information about a layout, font or a like is incorporated as a tag in a string of characters being a component of the document. The tag basically implements a function of markup, that is, of indicating a meaning of information contained in the HTML documents. Such the tag includes so-called “a tag” (anchor tag) performing a function of designating a place to which information is linked. The HTML document can express not only the character string but also multimedia information such as an image and/or voice.

Internal configurations of the BBS 11 will be described by referring to FIG. 1.

### Internal Configurations of BBS

As shown in FIG. 1, the BBS 11 is provided with a message registering section 15 serving as an information processing section 11a, a page generating section 16, a message DB (Database) 18, a translation processing section 17 making up a translation section 11b and a translation dictionary section 19 making up the translation section 11b.

The message registering section 15 performs processing of a message fed from the terminal device 13 or 14 on the BBS 11. To be more specific, the message registering section 15 feeds, in response to a request for registering the message fed from the terminal device, a part of the message to be translated by a translation machine, out of the messages (original language messages) consisting of an original language such as Japanese, to the translation processing section 17. The message registering section 15 further stores the original language message and a translated message obtained by translating the message using the translation machine to the message DB 18.

The translation processing section 17 translates the original language message to be translated fed from the message registering section 15 using data contained in the translation dictionary section 19 and then returns the translated results and the original language message to be translated back to the message registering section 15. In the first embodiment of the present invention, the translation processing section 17 performs the translation between two languages including Japanese and English.

Thus, when a Japanese message is input as the original language message, the Japanese message is translated into an English message by the translation processing section 17 and, when an English message is input as the original language message, the English message is translated into a Japanese message.

The translation dictionary section 19 has a function of translating, at least, from Japanese to English and stores dictionary data to translate from English to Japanese so that the translation processing section 17 can perform the translation processing as described above.

When the bilateral translation between two languages is not required, the translation processing section 17 can perform a unilateral translation (for example, translation from English to Japanese) and, in this case, the translation dictionary section 19 is so configured as to perform only the unilateral translation.

The translation dictionary section 19 contains vocabularies, grammar and special terminology to be used for the translation processing.

The message DB 18 stores the original language message and translated message fed from the message registering section 15 and manages these messages as a shared file whose contents can be fed to the terminal devices 13 and 14.

Each of the messages stored in the shared file is viewed on each of the terminal device as messages on the BBS 11.

Generally, a user of the BBS is allowed to read (or browse) posted messages from any number of the BBS users, however, a user who is allowed to write (amend or erase) a message is predetermined for each of the BBS 11.

The user of the BBS 11 who is allowed to amend or erase a message can be limited to, for example, a user who has transmitted the message (who has written the message) and a system manager of the BBS 11.

Each of the posted messages to be stored in the message DB 18 is stored in the data file. The original language message and the translated message corresponding to the original language message can be managed in the same file. If these messages are managed in separate files, a corresponding relation between the original language and the translated message has to be stored. If these messages are managed in the same file, the processing of storing such the relation is not required.

In the embodiment, the original language message and translated message are managed for each language by using different files. In the BBS 11 in which the translation between Japanese and English is performed, the message DB 18, as shown in FIG. 1, has at least a storage area FJ1 used to store the Japanese data and a storage area FE1 used to store the English area used to store the English data.

For example, when the original message is the message written in Japanese, the original message is stored in the storage area FJ1 used to store the Japanese data and the translated message being the result from the translation of the message is stored in the storage area FE1. Conversely, if the original language message is English, the English message is stored in the storage area FE1 and the product obtained by translating this message into Japanese is stored in the storage area FJ1.

Thus, each of the storage area FJ1 and FE1 stores the message written in the corresponding language irrespective of the original language message or translated message.

In the storage area FJ1 or FE1 described above, following posted information is written, together with the message content.

English (FE1)/Japanese, common: Message number and posted date

English (FE1)/Japanese (FJ1), different Message poster, title and message content

The information to be written in the message DB 18 is not limited to the above items and, if necessary, information can be added or deleted.

The above message registering section 15, translation processing section 17 and translation dictionary section 19 are operated to function when a message is posted and/or registered, while the above page generating section 16 is adapted to function when the message is browsed.

The page generating section 16, when receiving a message browsing request signal BR (not shown) used to make a request for browsing of posted messages from the terminal device 13 or 14, reads a file containing corresponding messages from each of the storage areas such as the storage area FE1 in the message DB 18 and, by using the file, produces message information (HTML documents) to be used in the Web pages that can be browsed. Then, the information is transmitted to the terminal device 13 (14) that has transmitted the message browsing request signal BR.

Each of the terminal devices 13 and 14 fed with the above message information, reads, by using the Web browser mounted therein, pages containing desired messages from the above information and then can browse this read page.

The message DB 18 is operated to function at the time of both registering the message and browsing the message.

In the embodiment, components 15 to 19 making up the BBS shown in FIG. 1 are mounted within one server machine, however, if necessary, one component or two or more components may be mounted separately in different server machines.

FIG. 13 is a schematic block diagram showing configurations of a main portion of each of the terminal devices 13 and 14 according to the first embodiment of the present invention.

Each of the terminal devices 13 and 14 may be configured to have substantially the same internal configurations. The configurations of the terminal device 13 will be hereinafter described by referring to FIG. 13.

### Internal Configurations of Terminal Device

The terminal device 13 is provided with an ordinary browser operating section 30, a language designating section 31, a posting form receiving request transmitting section 32, a posting form processing section 33 and a translational direction designating information adding section 34.

The ordinary browser operating section 30 performs a function required for browsing messages. More particularly, the ordinary browser operating section 30 receives input information IP fed from the key board device, pointing device or a like, posting form information FB or a like output by the posting form processing section 33 and produces output information OP to the bitmap display device.

The user operating the terminal device 13 can view visually contents corresponding to the output information OP on a screen of the bitmap display device.

Moreover, the ordinary browser operating section 30, when having received a receiving acknowledge signal AC showing that the BBS 11 has accepted the posted message, that is, the message registration has been completed, from the BBS 11 through the network 12, produces the output information OP to cause the content of the receiving acknowledge signal AC to be displayed on the screen.

The language designating section 31 connected to the ordinary browser operating section 30, after having received a language designating output IP1 used to designate a language corresponding to the input information IP from the ordinary browser operating section 30, outputs language designating information LP used to obtain a posting form (described later) corresponding to the language indicated by the language designating output IP1 from the BBS 11.

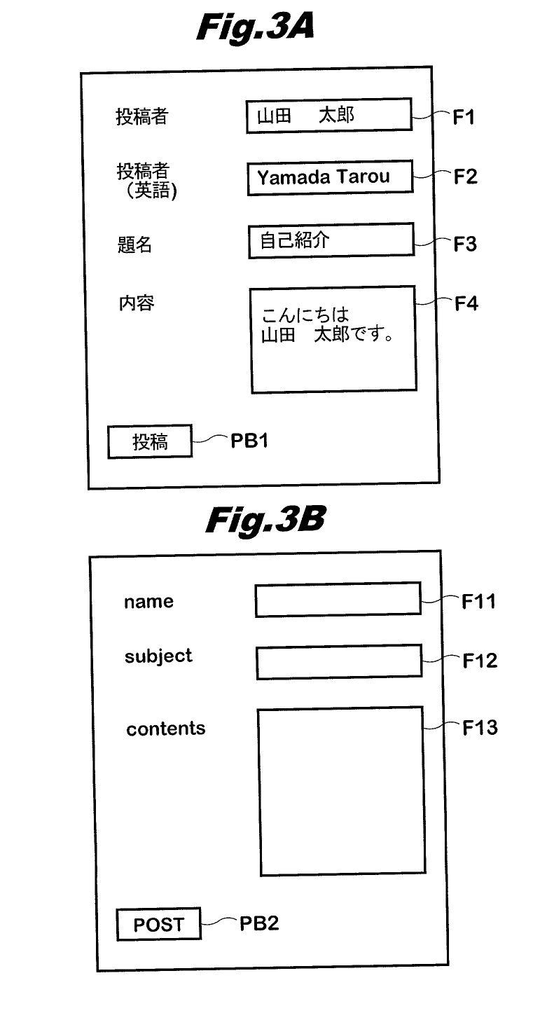

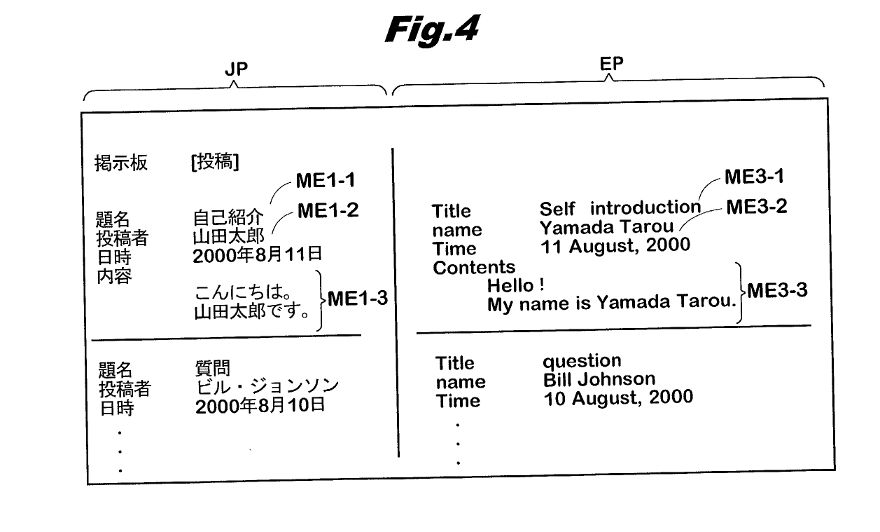

The user, prior to the message registration, receives, in advance, the posting form used to write the message from the BBS 11. The language designating information LP is information to designate a language to be used in the posting form. For example, if the posting form is one as shown in FIG. 3A, the language used for the posting form is Japanese. In the embodiment, either of Japanese or English can be designated by using the language designating information LP.

As the posting form for Japanese, the posting form as shown in FIG. 3A can be used and, as the posting form for English, the posting form as shown in FIG. 3B can be used. In FIG. 3A, a state in which the posted contents have been input in the Japanese form, however, in the initial state, a character string such as “ [symbol] ” or a like described in each of the editing boxes (text area) F1 to F4 does not exist.

The posting form receiving request transmitting section 32, as shown in FIG. 13, receives the language designating information LP from the language designating section 31 and transmits a posting form receiving request signal FR used to make a request asking the posting form corresponding to a language indicated by the language information LP of the BBS 11, to the network 12. The posting form receiving request signal FR is transmitted to a message registering section 15 of the BBS 11.

The posting form processing section 33 receives a posting form signal FF containing a posting form from the message registering section 15 in the BBS 11 through the network 12 and stores the received posting form signal FF in a temporary basis.

While the user is editing the posting message, state information FB, message describing information ME and posting designating signal RB are exchanged between the posting form processing section 33 and the ordinary browser operating section 30.

That is, the ordinary browser operating section 30 sequentially feeds contents indicated by input information IP fed by the user to the posting form processing section 33 as message describing information ME. The posting form processing section 33, every time it receives the message describing information ME, causes the content of the message describing information ME to be reflected on the posting form that the posting form processing section 33 is storing and then feeds sequentially the reflected content to the ordinary browser operating section 30 as the state information FB. The ordinary browser operating section 30, based on the state information FB fed from the posting form processing section 33, transmits the output information OP showing an input status of the posting form and causes its content to be displayed on the screen. This enables the user to describe the posted message while the user is confirming the content input to the posting form on the screen of the bitmap display device.

When the editing of the message by the user has been completed and when the content to be input to the form has been determined, a posting signal RB is fed from the ordinary browser operating section 30 to the posting form processing section 33.

When the input content described above has been determined, the user moves a mouse cursor (mouse pointer) to a posting button PB1 to click it, which then causes the posting signal RB to be output.

The posting form processing section 33, after having received the posting signal RB, transmits a signal RS to make a request for the translational direction (from Japanese to English) to the translational direction designating information adding section 34. The translational direction designating information adding section 34 returns back translational direction designating information DS corresponding to a translational direction indicating signal DP to designate the translational direction which has been, in advance, transmitted from the ordinary browser operating section 30, to the posting form processing section 33.

The posting form processing section 33, after having received the translational direction designating information DS, produces a posting signal MR by adding the translational direction designating information DS to the posting message and then transmits the posting message to the BBS 11 through the network 12.

According to the embodiment, even if the BBS 11 handles three or more languages, by using the translational direction designating information DS, the translational direction can be designated so that the translation is performed only between two languages.

In the BBS 11 of the embodiment, since only two languages of Japanese and English are used, the translational direction designating information DS serves simply as information used to indicate whether the translation is required or not.

When the posting signal MR to which the translational direction designating information DS indicating that “the translation is required” is transmitted from the terminal device, the BBS 11 operates to translate the Japanese message contained in the posting signal MR into English. Moreover, if the translational designating information DS indicates that “the translation is not required”, the Japanese message contained in the posting signal MR is not translated and is stored in a storage area (for example, in an area FJI) for the Japanese file in the message DB 18.

If the translational direction designating information DS indicates that “the translation is not required”, either of designation that only translated message as a translated result is stored in the message DB 18 or that each of the original language message and translated message is stored in the message DB 18, can be provided to the translational direction designating information DS.

When there is no special designation on the above points, in this embodiment, each of the original language message and translated message is written to each of corresponding files.

When the BBS 11 handles three languages, for example, English, Japanese and French, if the original language is Japanese, this Japanese message is translated into either English or French, or into both English and Japanese in accordance with the translational direction designated by the translational direction designating information DS and the translated message being the translated result is written into the message DB 18. As described above, this Japanese message may be written into the corresponding file without being translated.

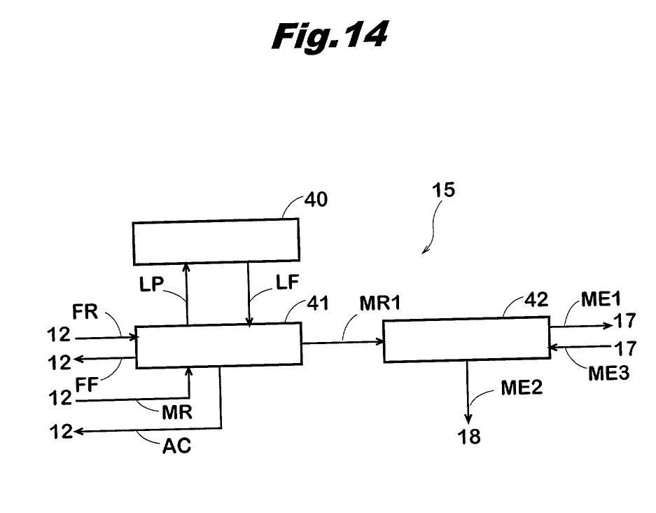

FIG. 14 shows an example of configurations of a main component of the message registering section 15 in the BBS 11 of the first embodiment of the present invention.

### Internal Configuration of Message Registering Section

As shown in FIG. 14, the message registering section 15 is provided with a language identifying section 40, a posting form handling section 41 and a message extracting section 42.

The posting form handling section 41 exchanges, through the network 12, the posting form receiving request signal FR, posting form signal FF, posting signal MR and receiving acknowledge signal AC with the ordinary browser operating section 30, with the posting form receiving request transmitting section 32 and with the posting form processing section 33 in the terminal device 13 (14) and performs, every time each of these communications is carried out, required processing.

In the posting form handling section 41 is installed a well-known CGI (Common Gateway Interface) program to implement functions described above. For example, the signal being a result from processing of the CGI such as the posting form signal FF is returned back to the terminal device in the HTML form that can be displayed by the general Web browser on the terminal device side. The posting form handling section 41 receives the posting form receiving request signal FR transmitted from the posting form receiving request transmitting section 32 in the terminal device 13 and regenerates (or extracts) the language designating information LP to designate a language of the posting form and then transmits this language designating information LP to the language identifying section 40.

The language identifying section 40 detects a language used in the posting form requested by the terminal device 13 from the language designating information LP fed from the posting form handling section 41 and feeds posting form language signal LF being a result from the detection to the posting form handling section 41.

The posting form handling section 41 feeds the posting form signal FF corresponding to the language indicated by the posting form language signal LF through the network 12 to the posting form processing section 33 in the terminal device 13. That is, in this embodiment, the posting form signal FF corresponding to Japanese is fed.

Moreover, the posting form handling section 41, when receiving the posting signal MR through the network 12 from the posting form processing section 33 in the terminal device 13, feeds a signal MR1 which is made up of the translational direction designating signal DS and the specified control information containing a packet header or a like and the posting message and which corresponds to the posting signal MR, to the message extracting section 42.

The message extracting section 42 extracts message data corresponding to strings of characters such as “ [symbol] ” or “ [symbol] [symbol] ” or a like as shown in FIG. 3A from the signal MR1 fed from the posting form handling section 41.

The message extracting section 42 refers to the translational direction designating signal DS contained in the signal MR1 and feeds a message ME 1 requiring the translation out of the above character string data to the translation processing section 17. Moreover, a message ME 2 requiring no translation such as Romaji “Yamada Tarou” as shown in FIG. 3A is fed to the message DB 18 and is stored in a shared file (FE1).

The message extracting section 42, after having a message ME 3 being a result from the translation of the message ME 1 from the translation processing section 17, feeds the message ME 3 to the message DB 18, together with the message ME1. Each of both the messages ME 1 and ME 3 is stored in each of the storage areas FJ 1 and FE 1.

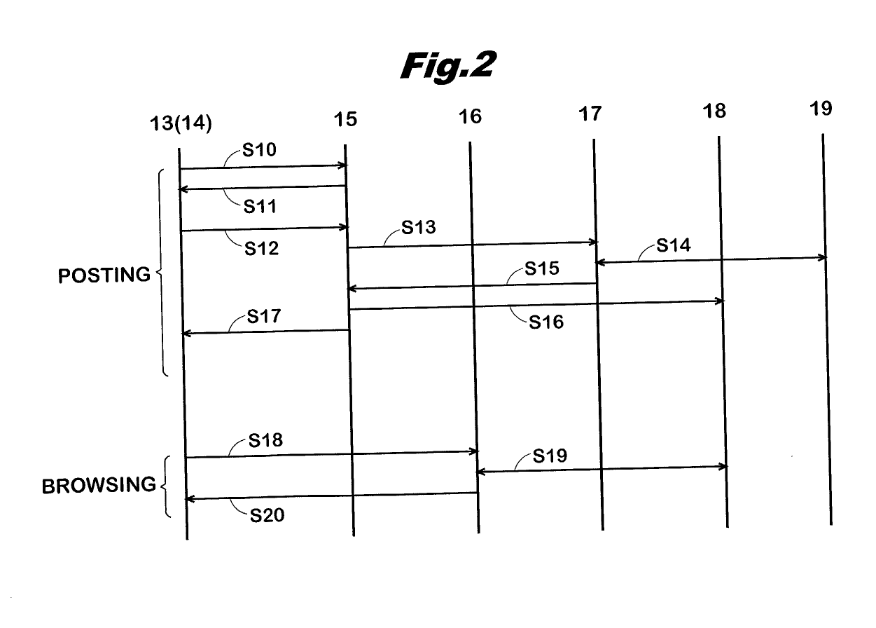

Operations of the hypertext system 10 of the embodiment will be described by referring to an operational sequence shown in FIG. 2.

The operational sequence is made up of procedures of Step S10 to S20 as shown in FIG. 2.

### Operations of First Embodiment

Here, a case is described in which a message posted by a user U1 of the terminal device who is not accustomed to use of English but accustomed to use of Japanese is read by a user U2 who is not accustomed to the use of Japanese but accustomed to the use of English.

For the user U1 to be able to obtain a Japanese posting form, the posting form receiving request signal FR corresponding to the language designating information LP indicating that a described language (language in the posting form) is Japanese is transmitted through the network 12 to the BBS 11 (Step S10).

The message registering section 15 in the BBS, after having received the posting form receiving request signal FR, returns the posting form signal FF corresponding to the Japanese posting form as shown in FIG. 3A back to the terminal device 13 (S11). When the posting form signal FF is fed to the terminal device 13, a posting form in an initial state as shown in FIG. 3A is displayed on the screen of the bitmap display device in the terminal device 13.

The posting form shown in FIG. 3A includes the editing box Fl used to describe names of message posters, editing box F2 used to describe names of message posters in an alphabetical notation, editing box F3 used to describe titles of the posted message, editing box F4 used to describe contents of the posted message and a posting button PB1 used to instruct posting processing.

When English is designated by the language designating information LP, the posting form written in English as shown in FIG. 3B is displayed. The posting form includes the editing box F11 used to describe names of users in English (or in an alphabetical notation), editing box F12 used to describe titles of messages in English, editing box F13 used to describe the message contents and a posting button PB 2.

When the strings of characters are input into each of the editing boxes F1 to F4 and F11 to F13, all editing functions required for inputting a text by the user can be used.

The user U1, while visually seeing the posting form on the screen, describes necessary items on each of the editing boxes F1 to F4.

For example, as shown in FIG. 3A, the character string “ [symbol] ” is described in the editing box F1, the character string “Yamada Tarou” in the editing box F2, the character string “ [symbol] ” in the editing box F3 and the character string “ [symbol] [symbol] ” in the editing box F4.

While these are being described, since the display on the screen changes depending on the process of description, the user is allowed to rewrite and/or delete the character string if necessary.

After the description on each of the editing boxes F1 to F4 has been completed and the described contents have been finally determined, when the user U1 operates the mouse and presses down the posting button PB1 on the screen, the posting signal MR is sent to the BBS 11 (S12). Let it be assumed here that, though the translational direction designating information DS indicating that the “translation is necessary” has been added to the posting signal MR, whether both the translated message and the original message have to be written or not on the BBS 11 has not been designated.

The message registering section 15 in the BBS 11, after having received the posting signal MR from the terminal device 13, extracts the message ME 1 to be translated from the posting signal MR and feeds the message ME to the translation processing section 17 (S13).

The translation processing section 17, using the translation dictionary section 19, translates the message ME 1 by using the translation machine and transmits a message ME 3 being the result of the translation to the message registering section 15 (S15).

Since the message ME 3 is the English message being the result from the translation of the Japanese message, it is written to the shared file FE 1 for the English message in the message DB 18 (S16).

Moreover, in Step S12, as described above, since it has not been designated whether both the translated message and the original language message have to be written or not, these both the messages are stored in the message DB 18. Therefore, in Step S16, when the translated message ME 3 (English) is written in the shared file FE 1, the original message ME 1 (Japanese) is written in the shared file FJ 1. That is, in order to maintain a relation between the original language message and translated message in the message DB 8, addresses related to each other in the message DB 18 are assigned to both the messages.

For example, as shown in FIG. 4, when the Japanese character string ME 1-1 (“ [symbol] ”) out of the original language messages is written to the shared file FJ1, the translated character string (“self introduction”) corresponding to the Japanese character string ME 1-1 is written in the shared file FE 1. Moreover, when the Japanese character string ME 1-2 (“ [symbol] ”) is written to the file FJ1, an alphabetical message ME 3-2 (“Yamada Tarou”) corresponding to the Japanese character string ME 1-2 is written to the file FE 1. When the Japanese character string ME 1-3 (“ [symbol] ”) is written to the file FJ 1, a translated character string ME 3-3 (“Hello ! My name is Yamada Tarou.”) is written to the file FE 1.

In the example shown in FIG. 4, in addition to the above example, a posted date and/or posted time is written. Such the data that can be known on the side of the BBS 11 may be produced automatically in the BBS 11 itself and be written automatically.

When the processing of writing all messages (character strings) contained in the posting signal MR transmitted from the terminal device 13 has been completed, the receiving acknowledge signal AC indicating the completion of the processing is transmitted from the message registering section 15 to the terminal device 13 (S17).

The terminal device 13 displays the message corresponding to the receiving acknowledge signal AC on the screen.

Time required from Step S12 in which the terminal device 13 posts the message to Step S17 in which the posted message is received is substantially not long.

Next, a case in which the user U2 being skillful at English browses messages on the BBS 11 using the terminal device 14 is explained by referring to Step S18 to S20 shown in FIG. 2.

First, the terminal device 14 transmits the message browsing request signal BR to make a request for the browsing of messages to the BBS 11 (S18). If the terminal device 14 makes the request for the browsing of a plurality of messages, a message ID used to identify each of the messages may be added to the above signal.

The page generating section 16 in the BBS 11, after having received the message browsing request signal BR from the terminal device 14, reads two shared files FE 1 and FJ1 corresponding to the message indicated by this signal and produces, using these two files, one HTML file bilingually describing the original message and translated message (S19). The content of the HTML file becomes a posted message on the BBS 11 to be browsed for the user U2.

When the HTML file has been read in the terminal device 14, the user U2 can browse desired posted messages using the ordinary browser operating section 30 (S20).

At this point, on the display of the terminal device 14 is shown the image as shown in FIG. 4.

Moreover, if the screen in a bilingual form is not necessary, only the English message may be displayed. In this case, in Step S19, only the English shared file FE1 is read to the page generating section 16 and the HTML file, based on the shared file FE1, is produced. This causes only the English region EP as shown in FIG. 4 to be displayed on the screen of the terminal device 14.

Conversely, if only the Japanese region JP is displayed, the HTML file, based on the Japanese shared file FJ1, is produced.

In order to cause the screen contents made up of the English region EP or the screen contents made up of the Japanese region JP to be displayed, browsing language designating information to designate the language for browsing (here, English or Japanese), for example, may be added to the message browsing request signal BR described in Step S18. This causes the shared file responding to the browsing language designating information to be read to the page generating section 16 (for example, if the browsing language designating information designates the English, the shared file FE1 is read) from the message DB 18 and causes the page generating section 16 to produce the HTML file based on the shared file FE1.

Since some users do not want the screen contents to be displayed in the bilingual form, it is preferable to provide not only the method to allow the screen content to be displayed in the bilingual form but also a method to allow messages to be browsed in one language being accustomed to the users using the above browsing language designating information.

Since the functions that the terminal device 14 has to implement in order to perform processing in Step S18 to S20 are those that the Web browser being widely and generally used possesses, even if the terminal device 14 is provided with the Web browser being widely and generally used, the BBS 11 can be browsed.

When an improper signal is sent to the BBS, for example, when any posting language is not designated in the posting form receiving request signal FR fed from the terminal device 14, the CGI program provided to the BBS 11 enables an automatic communication with the terminal device to obtain the proper signal from the terminal device 14.

As described above, according to the first embodiment of the present invention, since the BBS 11 has the function of the translation, it is not necessary for the individual terminal device of each user to be provided with the translation software, which eliminates the need for further complicated processing to manage the software. This enables an easy exchange of messages between the user who is familiar only to one specified language and other user who is familiar to other different language and therefore enables a user community through the use of the same BBS 11 to be established among two or more users each using a different language.

Such the user community can be made larger in scale compared with the conventional user community requiring the common language such as the English, which can possibly provide more worldwide communication, enhancing values of message exchanges.

For example, it is not necessary for the user who wants to know oversea topics or to send messages through the BBS 11 to read messages written in a language to which the user is not familiar or to write messages in the language to which the user is not familiar and therefore such the BBS 11 can provide increased ease of use to the user.

Even if the user is not accustomed to the use of English, the user can easily send out messages to all the world.

### Second Embodiment

Points of configurations and operations in a BBS of a second embodiment being different from those in the first embodiment will be mainly described below.

In the BBS 51 of the second embodiment, a service field of a posted message, that is, a category is managed in a form of a hierarchical structure used to express conceptual “containing and contained relation”.

Configurations and Operations in Second Embodiment

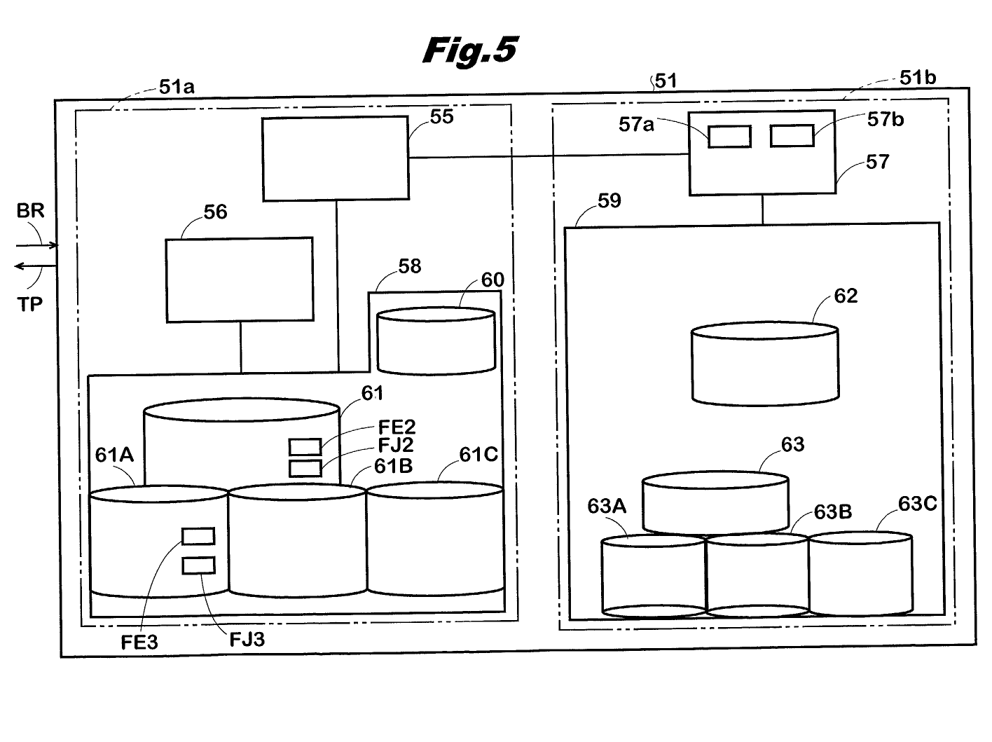

FIG. 5 is a schematic block diagram showing configurations of the BBS 51 according to the second embodiment of the present invention. As in the BBS 11 in the first embodiment, the BBS 51 is a part of the hypertext system 10. An information processing section 51a in the BBS 51 is provided with a message registering section 55, page generating section 56 and a message DB 58 having a managing information section 60 and a translation section 51b in the BBS 51 is provided with a translation processing section 57 and a translation dictionary section 59.

Functions of each component shown in FIG. 5 are the same as those of each component having a corresponding reference number in FIG. 1.

That is, functions of the message registering section 55 in FIG. 5 corresponds to those of the message registering section 15 in FIG. 1, functions of the page generating section 56 in FIG. 5 corresponds to those of the page generating section 16 in FIG. 1, functions of the translation processing section 57 in FIG. 5 corresponds to those of the translation processing section 17, functions of the message DB 58 in FIG. 5 corresponds to those of the message DB 18 and functions of the translation dictionary section 59 in FIG. 5 corresponds to those of the translation dictionary section 19 in FIG. 1.

In the BBS 51 of the second embodiment, each of the categories of posted messages is managed in the form of the hierarchical structures. The message DB 58 has a database classified by each category in the hierarchical structure and, in the example shown in FIG. 5, a sports DB 61 being a database for messages of sports and databases 61A to 61C for messages of a baseball, soccer and golf, respectively, each being a conceptual lower layer node of the sports, are provided.

As described above, the database 61A is the database for messages of the baseball contained conceptually in the sports, the database 61B is the database for messages of the soccer contained also conceptually in the sports and the database 61C is the database for messages of the golf contained also conceptually in the sports.

The translation dictionary section 59, as in the case of the message DB 58, has components classified in accordance with hierarchical categories. The translation processing section 57, based on the hierarchical structure, is provided with a specialized dictionary selecting section 57a used to select a dictionary corresponding to the category of messages to be translated and a translation executing section 57b used to perform the translation using one or more dictionaries selected by the specialized dictionary selecting section 57b.

In the translation dictionary section 59, there are provided a sports dictionary 63 including terminology related to sports, a baseball dictionary 63A including terminology related to the baseball and a soccer dictionary 63B including terminology related to the soccer and a golf dictionary 63C including terminology related to the golf.

For example, the golf dictionary 63C includes words that are used only in the golf such as “birdie [symbol] ”, “eagle [symbol] ” or a like and words that are used in sports other than the golf such as “club [symbol] ”, “shot [symbol] ” or a like are included in the sports dictionary 61 corresponding to a higher order category.

The translation dictionary section 59 has a common dictionary 62 being equivalent to a general system dictionary, in addition to each of the specialized dictionaries classified by category such as the sports dictionary 61, golf dictionary or a like. The common dictionary 62 includes general words having not so high degree of specialty in original languages in a form of a headword together with translated words corresponding the general words. The category corresponding to this common dictionary can be ranked as a root being the highest order node in the hierarchical structure described above.

In the message DB 58, not only the database of the sports described above but also a database of, for example, a travel can be constructed and, in this case, a travel message DB (travel message database) or a like are provided. It is considered to be preferable, from a viewpoint of efficiency and improvement in the translation processing, that the hierarchical structure for the message DB 58 corresponds to that for the translation dictionary section 59 and therefore if the travel message DB is provided in the message DB 58, a dictionary specialized in the travel is preferably provided in the translation dictionary section 59.

In the BBS 51, the message DB (61, 61A or a like) for each category managed in the form of the conceptual hierarchical structure has each of shared files (FE2, FE3 or a like) for a Japanese message and English message related to each category.

The managing information section 60 in the BBS 51 is a portion in which the classification based on the above hierarchical structure is managed and is one of components making up the message DB 58.

The managing information section 60 stores a category ID used to identify a category of posted messages, Japanese name of each of categories, its higher order category, for each category as field managing information.

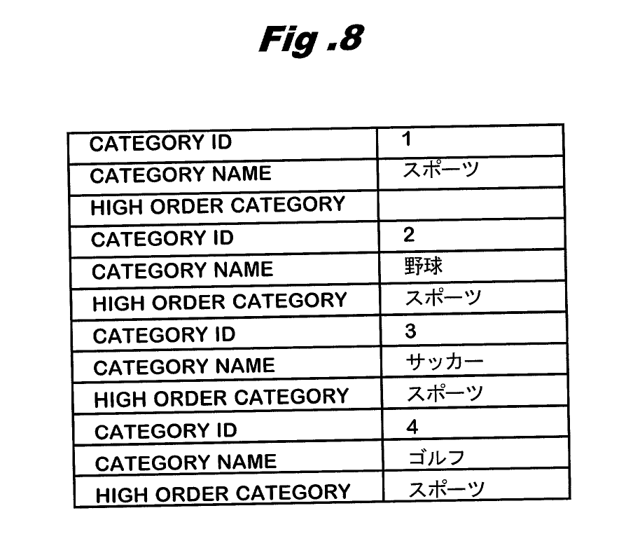

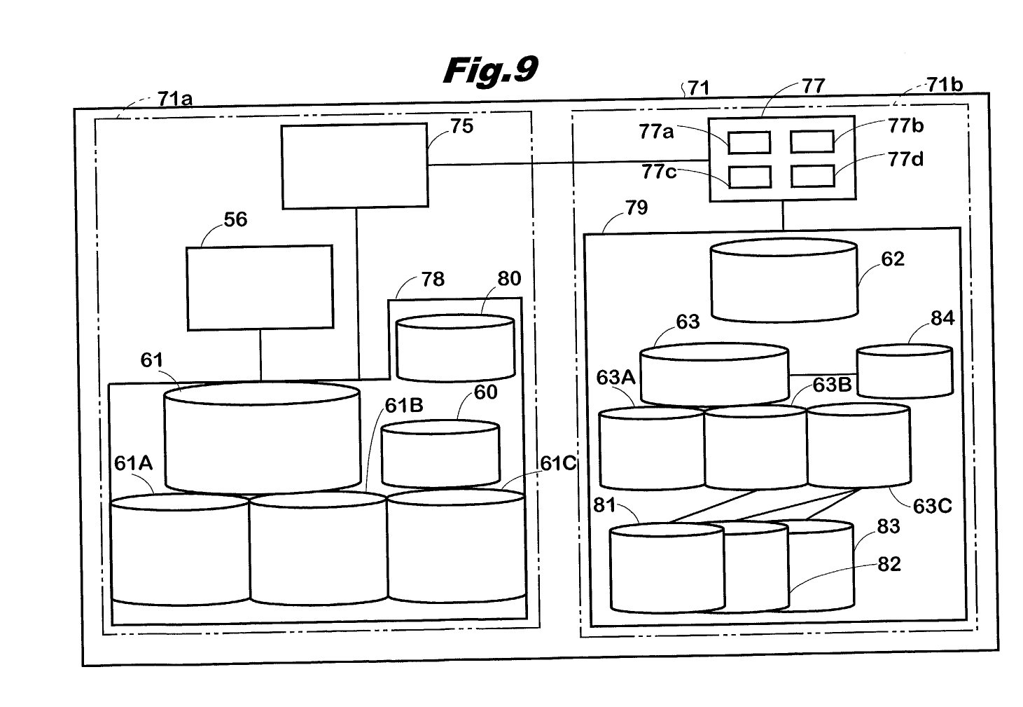

This field managing information can be configured, for example, in a manner shown in FIG. 8.

In the example shown in FIG. 8, English category names are omitted, however, the English category names may be added to the field managing information. In that case, the field managing information about, for example, the golf category can be configured as follows: Category ID: 4, Japanese category name: “ [symbol] ” (golf), English category name: “GOLF”, higher order category: “ [symbol] ” (sports).

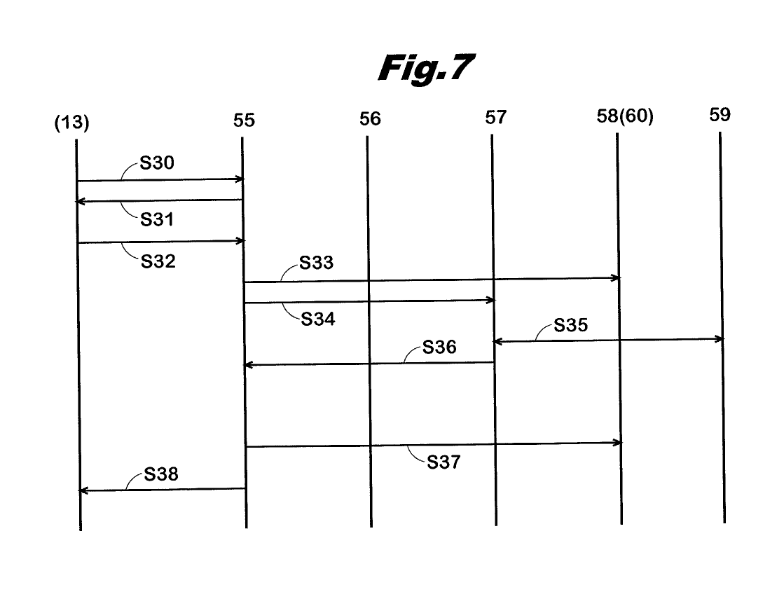

FIG. 7 shows an operational sequence of the BBS 51 according to the second embodiment of the present invention.

As shown in FIG. 7, the operation sequence is made up of Step S30 to S38. Many of these steps correspond to the Steps shown in FIG. 2.

That is, the Step S30 in FIG. 7 corresponds to the Step S10 in FIG. 2. Similarly, the Step S31 corresponds to the Step S11, the Step S32 to the Step S12, the Step S34 to the Step S13, the Step S35 to the Step S14, the Step S36 to the Step S15, the Step S37 to the Step S16 and the Step S38 to the Step S17.

In the second embodiment, hierarchically structured two or more categories are identified at the time of both browsing and posting messages.

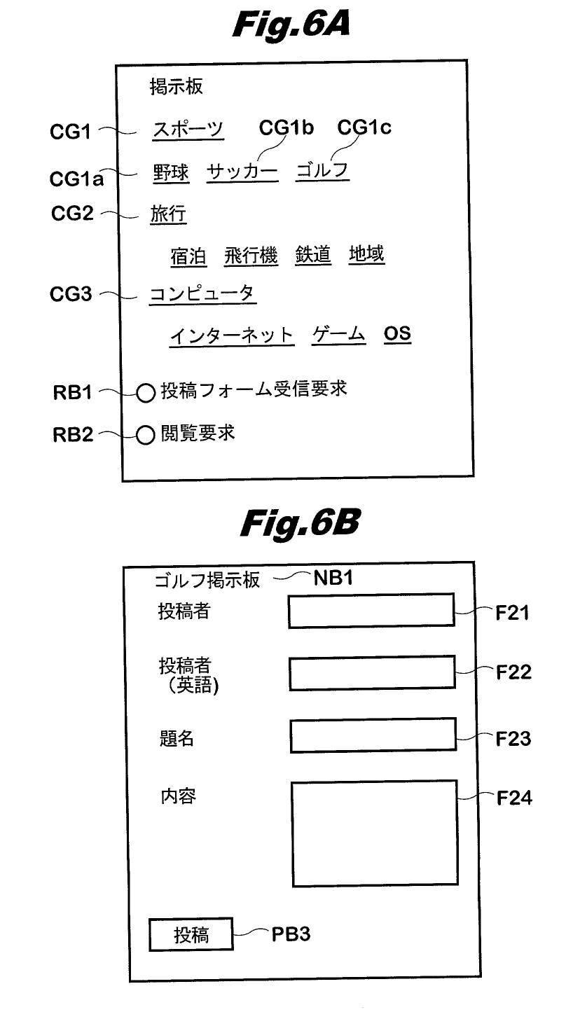

When the user posts messages, in order for the user to be able to select a desired category from these two or more categories, prior to the processing in Step S30, that is, prior to the processing by the terminal device 13 of making a request asking the posting form of the BBS 51, a browsing request signal BR is transmitted to the BBS 51 from the Web browser (the ordinary browser operating section 30) in the terminal device 13. This enables the terminal device 13 to receive a top page signal TP used to display the top page as shown in FIG. 6A from the BBS 51.

On a top page shown in FIG. 6A, each of categories such as a category CG1 “ [symbol] ” (sports), category CG2 “ [symbol] ” (travel) and category CG3 “ [symbol] ” (computer) is described. Out of the above categories, in the lower part of, for example, the category CG1 showing the name of the sports category, lower order category names such as a category CG1a “ [symbol] ” (baseball), category CG1b “ [symbol] ” (soccer), category CG1c “ [symbol] ” (golf) or a like are described.

Contents of the top page signal TP are described in HTML and, on the top page shown in FIG. 6A, the name of each of categories such as the sports, baseball or the like is associated with the pointer used to designate the corresponding message.

At a lower part of the top page described above, radio buttons RB1 and RB2 are provided. These radio buttons are control buttons used to make a selection being exclusive to each other. No filling-in on a mark for the button indicates that no selection has been made and filling-in indicates that the selection has been made.

The radio button RB1 “ [symbol] ” (posting form receiving request) is a button used to make a request for a posting form in order to post a message corresponding to a category that can be designated by the anchor tag contained in the HTML document. The radio button RB “ [symbol] ” (browsing request) is a button used to make a request for browsing a message corresponding to the category that can be designated by the anchor tag.

The user operating the terminal device can designate a desired category by first pressing down the radio button RB1 or RB2 and then moving a mouse cursor to a name of a field that the user want to browse or want to post a message to and clicking on the name.

For example, when the radio button RB1 to make the request for the posting form has been selected and the name of the category“ [symbol] ” (golf) has been clicked, the terminal device 13 (14), in Step S31 in FIG. 7, receives the posting form signal FF to display the posting form as shown in FIG. 6B on the screen. In the posting form, “ [symbol] ” (golf bulletin board) as a title NB1 showing a field on the BBS 51 is then described, which causes the user to confirm that the bulletin board to write a message on is the bulletin board for the golf field.

When the browsing is selected by the radio button RB2, the pointer corresponding to the field name, as described above, functions to read the corresponding message as the HYML document in the terminal device 13 and, when the posting is selected by the radio button RB1, the pointer functions to designate the title NB1 of the posting form requesting for transmission to the BBS 51.

However, even when the request for the posting form is selected, the pointer of the field name may function as the anchor tag to read messages on the BBS 51. This enables the user of the terminal device to describe messages in the posting form while browsing other messages.

In FIG. 7, the Step S33 to be performed between the Step S32 and the Step S34 does not exist in the first embodiment and is the Step specific to this second embodiment.

The terminal device 13 (14), in Step S32, transmits the posting signal MR containing a category ID (ID: 4) corresponding to the title NB1 for the golf bulletin board, to the BBS 51. The message registering section 55, in Step S33, refers to field management information managed by the managing information section 60, based on the category ID contained in the posting signal MR fed from the terminal device, and recognizes that a high order category of the golf category that corresponds to the category ID (ID: 4) is a sports category.

Next, the message registering section 55, in Step S34, takes out character strings described in each of editing boxes F23 and F24 showing “ [symbol] ” (subject) and “ [symbol] ” (contents) shown in FIG. 6B, from the posting signal MR and makes a request asking the translation processing section 57 to translate these character strings by using the translation machine. At this point, information is provided that the golf dictionary 63C and the sports dictionary 63 in its higher order category can be used.

The translation processing section 57, to execute the translation using the translation machine, is allowed to use two or more dictionaries including each of specialized dictionaries classified by category and common dictionary 62 or the like. In this case, it is preferable that the setting is made so that the dictionary in the lower order category is given a higher priority for use. It is also preferable that, if the dictionary in the low order category and the dictionary in the high order category has the same headwords in the original language and their translated words are different, the translated words in the low order category are employed. This is because such translated words as are registered in the dictionary in the low order category including the golf dictionary are possibly the words that are proper and suitable to practical use.

Therefore, when the message is posted in the posting form for the golf bulletin board shown in FIG. 6, each of the golf dictionary 63C, sports dictionary 63 and common dictionary 62 is used in order.

The message registering section 55, further in Step S37, registers the translated message and/or original message on a shared file stored in the message DB 61C for the golf category designated by the category ID.

As described above, according to the second embodiment of the present invention, the same effects as obtained in the first embodiment can be achieved.

Additionally, since the BBS 51 of the second embodiment is provided with the specialized dictionaries classified by category and since the specialized dictionary in the corresponding field is automatically selected at the time of the translation, proper translated words with a high degree of reliability can be obtained.

Moreover, since the translation is performed by using the specialized dictionary in the high order category corresponding to the hierarchical structure for the category, the translation of high quality can be expected in the second embodiment.

Generally, to translate words of high specialty, retrieval of many dictionaries are required. Therefore, according to the second embodiment, since each category corresponding to each dictionary is classified, based on the hierarchical structure, the retrieval of words can be efficiently performed. This enables costs for operating the BBS 51 to be reduced.

### Third Embodiment

Points of configurations and operations in a BBS of a third embodiment being different from those in the first and second embodiments will be mainly described below.

The BBS 71 of the third embodiment is provided with a user dictionary corresponding individually to each of terminal devices (or each user) and, when messages are registered or read, translated message that can meet a desire of each user can be provided.

The configurations of the BBS 71 of the third embodiment are shown in FIG. 9. As in the case of the BBS 11 of the first embodiment, the BBS 71 is a part of the hypertext system 10.

Functions of each component shown in FIG. 9 are the same as those of each component having a corresponding reference number in FIG. 5.

That is, functions of a message registering section 75 correspond to those of the message registering section 55, functions of a translation processing section 77 to those of the translation processing section 57, functions of the message DB 78 to those of the message DB 58 and functions of a translation dictionary section 79 to those of the translation dictionary section 59.

Moreover, in FIG. 9, functions of the components 56, 60, 61, 61A, 61B, 61C, 62, 63, 63A, 63B and 63C are the same as those of components having the same reference numbers in FIG. 5.

The BBS 71 of the third embodiment is further provided, within the translation dictionary 79, with user dictionaries 81 to 84, serving as terminal responding dictionaries, made up of original languages and translated words registered by the user using the terminal device 13 (14). Each user may have one or a plurality of these user dictionaries. The translation processing section 77 includes a user dictionary information section 77c having information about a relation between the user dictionaries 81 to 84 and each of terminal devices 13 (14) and a user dictionary selecting section 77d used to select a translation dictionary in response to an instruction, fed from each terminal device, contained in the above information of the user dictionary information section 7c.

A message DB 78 has a personal information managing section (personal information database) 80, described later, used to manage personal information that has been registered by a user.

As the personal information managed by the personal information managed by the personal information managing section 80, for example, a name of a message poster on the BBS 71, electronic mail address, browsing language/posting language, name of user dictionary, name of bulletin board used or a like can be registered.

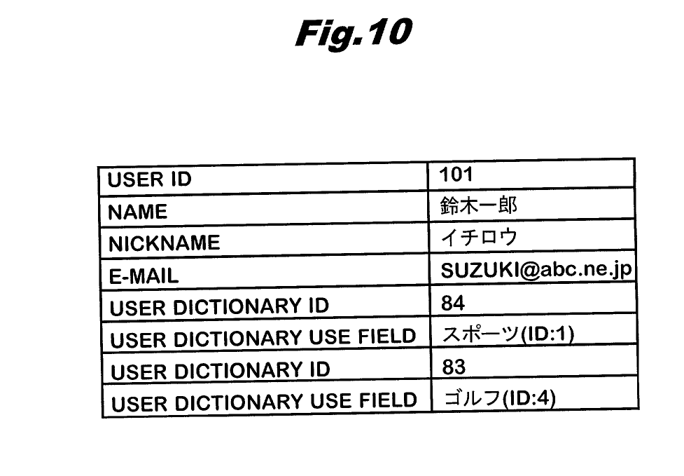

As the personal information, for example, as shown in FIG. 10, are stored a user ID “101” used to identify the user who is an operator of the terminal device 13 (14) and is also a message poster or a message browser, a user name “ [symbol] ” (Suzuki Ichirou), a nickname of the user “ [symbol] ” (Ichirou), an electronic mail address “suzuki@abc.ne. jp”, a user dictionary ID used to identify the user dictionary registered by the user, “ [symbol] ” (sports) being a category (use field) of the user dictionary (here, the user dictionary 84) designated by the user dictionary ID and its ID (ID: 1), a user dictionary ID (83) used to designate other user dictionary registered by the user and “ [symbol] ” (golf being a category (use field) of the user dictionary (here, the user dictionary 83) designated by the user dictionary ID and its ID “ID: 4”.

Of the above items listed as the personal information in FIG. 10, in the BBS 71 of the third embodiment, the user ID, user dictionary ID and user dictionary use field are used for selection of the user dictionary.

Each of the user dictionaries (83 or 84) designated by the user dictionary ID in FIG. 10 is associated with each of specialized dictionaries each corresponding to each of the user dictionary use fields (sports or golf) in FIG. 10 and each of the user dictionaries is used as a part of the corresponding specialized dictionary when the translation is performed by the translation processing section 77 using the translation machine.

For example, a relation between the sports dictionary 63 and the user dictionary 84 is the same as that between the high order category dictionary and the low order category dictionary in the second embodiment. Therefore, the headwords (in original language) in the user dictionary 84 and sports dictionary 63 are the same and, if the translated words included in the dictionaries 84 and 63 are different from each other, the translated word in the user dictionary 84 is employed. This is because there is high possibility that the translated word included in the user dictionary can provide the proper and suitable translation.

The user dictionaries 81 to 84 can be used not only when a new translated word not included in specialized dictionaries such as the sports dictionary 63, baseball dictionary 63A or a like is desired to be registered but also when a headword and its translated word not included in such specialized dictionaries is desired to be registered.

A right to register a new word or a new translated word on each of the user dictionaries or to perform manipulation of the dictionary for deleting an existing headword or its translated word from the dictionary can be possessed by the user who has registered the dictionary and by a manager who is managing the BBS 71.

The right to manipulate the common dictionary 62 or specialized dictionaries (63, 63A) other than each of the user dictionaries is preferably possessed only by the manager of the BBS 71 and free manipulation of the dictionaries by the user is preferably prohibited. This is because, since the common dictionary or specialized dictionaries are commonly shared by many users operating the BBS 71, if each user's free manipulation of these dictionaries is permitted, stable and high quality translation is made difficult and a problem associated with security occurs.

Moreover, even if the manager of the BBS 71 has the right to manipulate the user dictionary, since the manager does not manipulate the user dictionary except in the extraordinary cases, only the user who has registered the user dictionary manipulates the dictionary in ordinary cases.

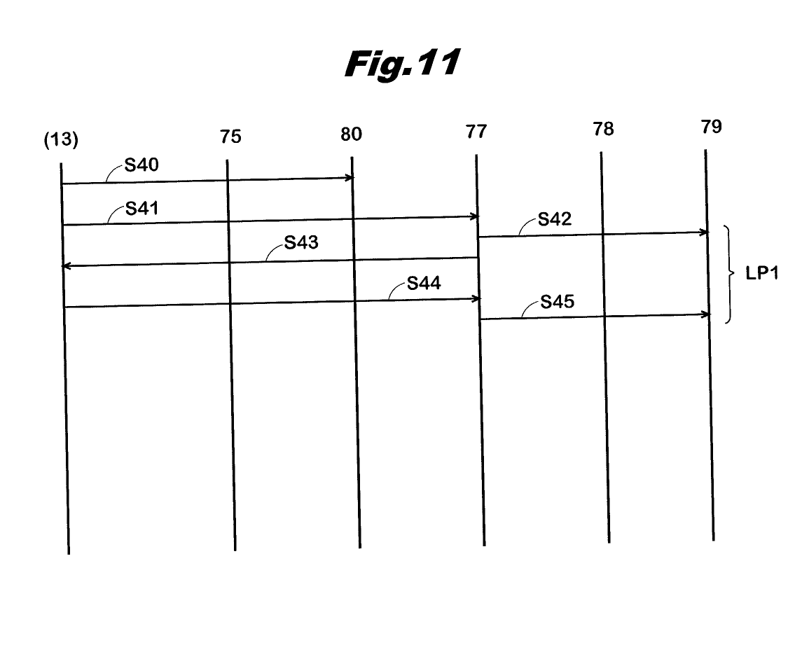

Operational sequences in which the user operating the terminal device 13 registers a new user dictionary on the translation dictionary section 79 in the third embodiment are shown in FIG. 11. The operational sequences shown in FIG. 11 are made up Steps S40 to S45.

The user, after having logged in to the BBS 71 from the terminal device 13, writes personal information shown in FIG. 10 including information about which category bulletin board the user dictionary is used for, to the personal information section 80 (S40).

In the example shown in FIG. 10, the user is one that is designated by the user ID “101” and the new user dictionary that the user registers is the user dictionary 84 used for a message of the sports category.

Then, when a signal, containing information showing the user ID “101”, used to make a request for the start of word registration is transmitted to the BBS 71, word registering processing is started. In the BBS 71, the translation processing section 77 mainly performs the processing related to the word registering (S41).

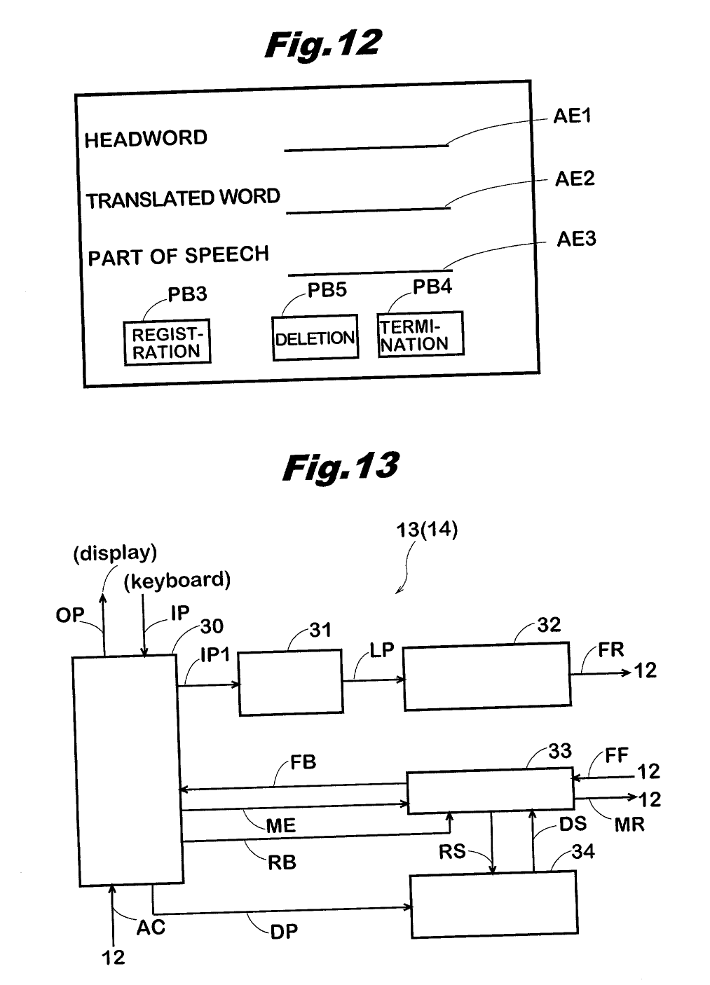

That is, the translation processing section 77, when receiving the signal requesting for the start of the word registering, secures a storage region, in the translation dictionary section 79, in which words to be included in the user dictionary 84 can be stored and notifies that the registration of headwords or translated words is made possible to the user. At the same time, in order to urge the user to register the word, the translation processing section 77 makes a request asking the terminal device 13 to display such the screen for the word registration as shown in FIG. 12 (S43).

On the word registering screen shown in FIG. 12, a text area AE1 used to describe a headword, test area AE2 used to describe a translated word for the headword and test area AE3 used to describe a part of speech for the headword or translated word are provided. Moreover, at a lower part of the word registering screen, push buttons are provided including a register buttonPB3 used to instruct the BBS 71 to register the word, termination button PB4 used to instruct word registration and word deletion to be terminated and deletion button PB5 used to instruct the word to be deleted.

After the word registering screen has been displayed at the terminal device 13, when the user performs the description required for each of the text areas AE1 to AE3 and presses down the register button PB3, the registering word information being information on each of the text areas AE1 to AE3 is transmitted to the translation processing section 77 in the BBS 71 (S44).

Then, the registering word information is stored by the translation processing section 77 into the storage regions secured in Step S42 (S45). This causes the first word registering in the user dictionary to be terminated.

For word registering continued thereafter, the processing (loop LP1) in Step S42 to S45 is repeated a required number of times.

To terminate a series of word registering processing in the loop LP1, when the user presses down the termination button PB4, a signal requesting for the termination of dictionary registration is transmitted from the terminal device 13 to the translation processing section 77 and the repeated processing in the loop LP1 is stopped.

Moreover, if necessary, the translation processing section 77 may be so configured as to notify that the translation processing section 77 has received the signal requesting for the termination of dictionary registration, to the terminal device 13.

After the termination of the registration, at any time, by transmitting a signal requesting for the start of the word registration in Step S41, the word registration on the user dictionary 84 can be resumed.

The manipulation of the dictionary for word deletion can be carried out in the same way as for the word registration. However, for example, in the case of the word deletion for deleting the existing headword or translated words, by pressing down the deletion button PBS instead of the registration button PB3, the word deletion in response to the designation in the text area AE1 or AE2 or a like can be performed.

Processing other than the dictionary manipulation in the embodiment can be performed in almost the same way as in the second embodiment.

However, in the third embodiment, when the user dictionary is used for the translation, it is necessary to confirm the user ID and category ID. Therefore, for example, when the message is posted, addition of the user ID and category ID is required at the time of transmitting the signal requesting for the posting form or of the posting form.

For example, when the terminal device 13 transmits the request signal for receiving the posting form or posting form to the BBS 71, if the “4” has been designated as the category ID and the “101” as the user ID, the message registering section 75 in the BBS 71 refers to the field managing information, shown in FIG. 8, managed by the managing information section 60 and recognizes that the higher order category of the golf category having the category ID “4” is the sport category having the category ID “1”.

Then, the message registering section 75 refers to personal information, shown in FIG. 10, managed by the personal information managing section 80 and recognizes that the dictionary that can be used for the present translation is two dictionaries, one being the user dictionary 83 in the golf field and the other being the user dictionary 84 in the sports field, out of the user dictionaries registered by the user having the user ID “101”.

Therefore, the user dictionary 83, golf dictionary 63C, user dictionary 84, sports dictionary 63, common dictionary 62, in this order, can be used for the present translation.

As described above, according to the BBS 71 of the third embodiment, the same effects as obtained in the second embodiment can be achieved.

Additionally, according to the third embodiment, since each of the user dictionaries can be used for the translation by the translation machine, the translated word desired by each of the user can be employed at the time of the posting and browsing on the BBS and the translated message that can meet the desire of each of the users can be obtained. Therefore such the BBS 71 having configurations described above can provide increased ease of use to the user.

### Other Embodiment

In the above first to third embodiments, the CGI program is used for communication between the terminal device and the BBS, however, Java program may be employed instead of the CGI program.

The CGI program is installed on the posting form handling section 41 in the BBS and is executed within the BBS. Each of signals obtained by the execution of the CGI program is fed to the terminal device through the network. On the other hand, when the Java program is used, a specified code of the Java program serving as an intermediate code not depending on types of the terminal device is downloaded in the terminal device and the Java program is carried out on the terminal device side.

Therefore, in an environment where a browser that can respond to the Java operation is installed on the terminal device side, the Java program is executed, which can provide user interface being interactive and full of power of expression.

It is apparent that the present invention is not limited to the above embodiments but may be changed and modified without departing from the scope and spirit of the invention. For example, examples of configurations of the posting form shown in FIG. 3A and FIG. 3B, those of the top page or the posted screen shown in FIG. 6A and 6B and those of configurations of personal information shown in FIG. 10 are merely a part of the examples and the present invention is not limited to these.

Moreover, in the first and second embodiments, the present invention is applied to the hypertext system (WWW), however, it may be applied to the BBS using the conventional personal computer communication method.

In the case of the conventional BBS, a simple CUI (Character User Interface) is used for the user interface and command inputting by the user is required. However, since program codes used for providing the user interface becomes very small in scale, memory capacity used in the terminal device is made small and a load imposed on the machine processing capability is reduced, thus possibly improving processing speed.

Moreover, according to the present invention, since the communication in Step S11 to S17 is carried out for a short time, the present invention may be applied to a Chat system being operated as one of the BBS.

When the BBS of the present invention is applied to a new server on the Internet, information written in unaccustomed languages such as foreign news can be translated into accustomed languages momentarily and can be browsed or read, which can provide a network news system with ease of use to the users.

In the above embodiments, contents of the signal exchanged between the BBS and the terminal device are described in HTML, however, they may be described in a markup language such as an XML (Extensible Markup Language).

The present invention may be applied not only the Internet but also an intranet and other computer networks.

What is claimed is:

1. An electronic bulletin board system connected to a communication network for feeding at least one of an original message posted through said network from a terminal device connected to said network and its translated message to a plurality of terminal devices including said terminal device comprising:
a translation section to produce said translated message corresponding to said original message posted through said network by translating said original message using a translation machine, prior to feeding of said message, to each of said terminal devices; and
an information processing section to hold said original message and said translated message and to feed message information containing at least one of said both messages in response to a request from each of said terminal devices, to each of said terminal devices.

2. The electronic bulletin board system according to claim 1, wherein said information processing section is provided with a storing section to store said original message and said translated message, a message processing section to judge, based on said request from each of said terminal devices, whether said original message is translated using said translation machine or not and to feed said original message to said storing section and with a message feeding section to produce said message information using said message from said storing section and to feed said message information through said network to each of said terminal devices.

3. The electronic bulletin board system according to claim 2, wherein said message processing section feeds said translated message to said storing section.

4. The electronic bulletin board system according to claim 3, wherein said translation section is provided with a dictionary section storing translation dictionary data used to perform said translation by said translation machine and with a translation processing section to perform said translation by said translation machine using said dictionary data stored in said dictionary section.

5. The electronic bulletin board system according to claim 4, wherein said original message and said translated message stored in said storing section are classified by category and wherein said storing section is provided with a managing information section having information about said category.

6. The electronic bulletin board system according to claim 5, wherein said dictionary section has a plurality of specialized dictionaries classified by said category and common dictionaries other than said specialized dictionaries.

7. The electronic bulletin board system according to claim 6, wherein said category is so systematized as to have hierarchical structures.

8. The electronic bulletin board system according to claim 7, wherein said translation processing section is provided with a specialized dictionary selecting section to select said specialized dictionary that corresponds to a category of said original message to be translated and said specialized dictionary that corresponds to a category showing a higher order concept of said category from said specialized dictionaries and with a translation performing section to perform said translation by said translation machine using one or a plurality of said specialized dictionaries selected by said specialized dictionary selecting section.

9. The electronic bulletin board system according to claim 6, wherein said dictionary section has one or a plurality of user dictionaries that responds to at least one of said terminal devices.

10. The electronic bulletin board system according to claim 9, wherein each of said user dictionaries is classified by category corresponding to each of said specialized dictionaries.

11. The electronic bulletin board system according to claim 10, wherein said translation processing section is provided with a user dictionary information section having information about a relation between each of said terminal devices and each of said user dictionaries and with a user dictionary selecting section to select said user dictionaries that meet an instruction, fed from each of said terminal devices, contained in said relation information stored in said user information section.

12. An electronic bulletin board system connected to a communication network for feeding at least one of an original message posted through said network from each of a plurality of terminal devices connected to said network and its translated message to a plurality of terminal devices including said terminal device comprising:
a translation section to produce said translated message corresponding to said original message posted through said network by translating said original message using a translation machine prior to feeding of said message, to each of said terminal devices; and
an information processing section to hold said original message and said translated message and to feed message information containing at least one of said both messages in response to a request from each of said terminal devices, to each of said terminal devices.
